(19) United States
(12) Patent Application Publication
(10) Pub. No.: US 2003/0228857 A1
(43) Pub. Date: Dec. 11, 2003

(54) Optimum scan for fixed-wireless smart antennas

(75) Inventor: Akira Maeki, San Jose, CA (US)

Correspondence Address: David T. Cunningham, Esq., Hitachi America, Ltd., 50 Prospect Avenue, Tarrytown, NY, 10591, US

(73) Assignee: Hitachi, Ltd., Tokyo (JP)

(21) Appl. No.: 10/163,852

(22) Filed: Jun. 6, 2002

(51) Int. Cl. H04B 1/06

(52) U.S. Cl. 455/278.1; 455/277.1; 455/277.2

(57) ABSTRACT

Events determine the timing of when to change performance, for example when to scan or when to use a prior stored usually best-performance configuration or just a last configuration, for a smart antenna in a fixed or almost fixed usage like a wireless local area network and a television system. Thereby the system maintains unchanged the parameters, such as those that determine the beam form of the smart antenna until monitoring recognizes one or a combination of more than one of the following conditions or event occurrences; the device communicate with another device for the first time; reboot of the device or the device turns on; the received signal exceeds a predetermined bit error rate (BER); the received signal strength indicator (RSSI) is less than a determined RSSI; the received signal goes below a predetermined signal to noise ratio (SNR); and a user's demand. The performance is changed by changing of the communication parameters, for example: the previous measured configuration data to reduce the scan area and reduces the scan time; control of the transmission power of the communicating device to maintain performance or quality; channel selection to minimize collision in the transmission; switching to the another antenna; change the data rate; and change the modulation scheme. Maintaining the communication with another antenna during the scan of one smart antenna is another key point.

### FIELD OF THE INVENTION

The present invention relates generally to wireless communication systems an adaptive sectored or smart antenna..

### BACKGROUND OF THE INVENTION

Wireless LANs (Local Area Networks) and Digital TV systems with smart antenna systems are easier to be realized because most of the devices are stationary, or at least most of the users do not move very fast or very often, during operation, and the indoor environment results in multi-path degradation. This is especially true of OFDM (Orthogonal Frequency Division Multiplexing) systems, which are often used for home wireless communication because of a natural superiority in respect to multi-path degradation and a large power consumption that would generally be unsuitable for mobile devices. The smart antenna systems can help reduce the power consumption dramatically by narrowing the beam form without a loss of performance and increase the system capacity.

There is an increasing demand for wireless communications in the home or workplace. For example: a user of a portable laptop computer does not want to be tethered to a particular desk or work area and, instead, demands the flexibility of portable devices (e.g., a laptop, PDA, etc.); consumers demand a reduction in the number of physical wires and connections that are needed between the electronic devices found in one's home and workplace; and it is desired to have a single access point for multimedia data (e.g., a cable television connection) and a wireless connection between that access point and consumer appliances that play or record such data.

Electronic devices wireless communicate with other devices at preferably a high data rate, but such high rates make the system sensitive to disturbances that will affect the system communication performance to where it may easily become unsatisfactory. For example, since each home essentially employs the same frequency bands, there is a high degree of probability that the communications systems in adjacent homes (e.g., those in neighboring homes) interfere with each other.

The U.S. Pat. No. 6,009,124, issued to Smith et al and dated Dec. 28, 1999, describes a high data rate communications network employing an adaptive sectored antenna and how to optimize the smart antenna configuration by comparing training signals to predetermined BER and RSSI thresholds.

In Smith et al, upon determining that a station is initiating communication or requesting communication, the method initiates transmitting the training sequence. Scanning is performed until measured BER and RSSI values for the training signals both exceed their thresholds.

In Smith et al, scanning is performed continuously at intervals by a protocol that periodically sends a convergence command to a state machine to reacquire the training signal.

To accomplish the above scanning, the Smith et al patent discloses a first comparator for receiving the BER signal and a predetermined BER signal, comparing the BER signal to the predetermined BER signal, and selectively generating a BER PASS signal when the BER signal is less than the predetermined BER signal; and a second comparator for receiving the RSSI signal and a predetermined RSSI signal, for comparing the RSSI signal to the predetermined RSSI signal, and for selectively generating a RSSI PASS signal when the RSSI signal is greater than the predetermined RSSI signal. The presence of both the BER PASS signal and the RSSI PASS signal at the same time indicates that valid data is being received or transmitted successfully at high quality that is suitable for the usage. If the BER signal is greater than the predetermined BER signal or the RSSI signal is less than the predetermined RSSI signal, a beam steering state machine spatially steers the antenna array a predetermined amount, and then continues to check the BER signal and the RSSI signal while receiving the training signals to steer the antenna array until both the predetermined BER threshold and the predetermined RSSI threshold are obtained, so that thereafter valid data (non-training signals) can be received or transmitted. The disclosure of the Smith et al patent is incorporated herein in its entirety, particularly for the implementation of scanning and the control of the scanning by the comparators.

The U.S. Pat. No. 6,236,839 B1, issued to Gu et al. on May 22, 2001, describes calibrating a smart antenna array by using training signals.

The U.S. Pat. No. 5,260,968, issued to Gardner et al on Nov. 9, 1993, describes multiplexing communication signals through blind adaptive spatial filtering. A beam-forming algorithm for an antenna array is based on the reception pattern at another communicating device. Weighting factors are employed. The disclosure of the Gardner et al patent is incorporated herein in its entirety, particularly for the implementation of weighting factors.

WO 01/28037 A1 to Masenten et al., published Apr. 19, 2001, describes a digital modular adaptive antenna and method, which requires coupling each antenna element to a weighted circuit and also to a previous weighting circuit within a previous array element module in a concatenated manner.

The U.S. Pat. No. 6,141,567, issued to Youssefmir et al. on Oct. 31, 2000, describes smart antenna receiver beam forming in a changing-interference environment, with adjustment of the process and weights using two sets of measured data, wherein one set is with respect to known characteristic information and the other set is with respect to unknown characteristic information, so that less computational resources are required in the changing environment.

The U.S. Pat. No. 6,122,260, issued to Liu et al. on Sep. 19, 2000, describes a smart antenna CDMA wireless communication system, which utilizes particular characteristics for increasing the capacity and quality of wireless communications. Uplink beam forming vectors are designed to minimize the bit-error-rate (BER).

The U.S. Pat. No. 6,219,561 B1, issued Apr 17, 2001 to Raleigh, describes an array of antennas in a wireless communication network using time-varying vector channel equalization for adaptive spatial equalization and an adaptive equalizer.

The U.S. Pat. No. 6,229,486 B1, issued May 8, 2001 to Krile, describes a subscriber based smart antenna, which monitors both selected antenna configuration and all configurations at the same time. The antenna elements of the array are rapidly and individually scanned, and the resulting signal to noise ratios are compared to a threshold to determine if the array should be reconfigured.

WO 01/39320 A1 to Reudink et al., published May 31, 2001, describes remote stations with smart antenna systems and a method for controlling beam directions.

### SUMMARY OF THE INVENTION

The present invention eliminates required scanning upon start, which is advantageous in eliminating this delay in transmitting valid data, particularly for a relatively fixed environment where the need for scanning is less frequent than and the amount of scanning is generally less severe than in a more mobile environment, as determined by the inventor as a part of the present invention. For example, it is recognized herein that it is not necessary to scan every time you turn on a wireless communicating PC or TV, and frequently it is satisfactory to use the previous antenna configuration.

The present invention does not require the additional transmission of training signals to scan the smart antenna, which is advantageous as it saves the room for the data to be transmitted. Training signals may be used with the present invention, for example, for error correction. The invention is particularly useful in adapting smart antenna technology to a relatively fixed environment where the need for scanning is less frequent than and the amount of scanning is generally less severe than in a more mobile environment, as determined by the inventor as a part of the present invention.

The present invention eliminates required continuous scanning, which is advantageous in eliminating this delay in transmitting valid data, particularly for a relatively fixed environment where the need for scanning is less frequent than and the amount of scanning is generally less severe than in a more mobile environment, as determined by the inventor as a part of the present invention.

Accordingly, the invention addresses the need for a high performance, high data rate communication system that reduces the interference without interrupting or delaying the transmission of valid data to the extent of the delays and interruptions of the prior art, which is particularly useful with a smart antenna for wireless communication in a relatively fixed environment.

Further, the invention addresses the need to reduce power consumption that is spreading out of the mobile battery powered environment into all environments for general energy conservation.

The invention specifies operation of a smart antenna, for example an adaptive sectored antenna, with particular advantages in a fixed wireless environment, in order to reduce component cost and reduce power consumption.

The embodiment of the present invention scans and minimizes the required scanning time and effort to maintain good wireless communication performance, particularly by reducing the numbers and times of the scanning for maintaining good communication quality.

As a part of the present invention, it is recognized that in a fixed environment, it is not critical that a smart antenna scans prior to every transmission. This recognition led the inventor to the further part of the present invention of performing a scan when the antenna performance degrades a certain amount. The embodiment system reuses a former antenna configuration when the antenna performance degrades a certain amount, which is practical because of the relatively fixed environment.

The prior art does not store previous antenna configurations for future use, as is done in the present embodiment. The storage of the embodiment is preferably in the form of a table that links antenna configuration to measured performance, particularly with respect to valid data transmission, which table is generated and renewed with previous measurements that are preferably renewed and stored for every scan.

According to the invention, the beam form employed for wireless communication is changed upon the occurrence of one or more of the following events:

Rebooting or turning on of the smart antenna systems; a start event. The previous antenna configuration is loaded for the initial operation upon rebooting or start-up.

The beam forming device communicates with another device for the first time; a start event. The previous antenna configuration is loaded upon wireless communicating with another device for the first time.

The received signal of the beam forming device is below a predetermined bit error rate (BER); a valid data monitoring response event. The embodiment system performs a succession of changes and evaluation of the changes, for example with the last change being the reuse of a former antenna configuration when the monitored antenna performance degrades a certain amount.

The received signal strength indicator (RSSI) of the beam forming device is less than a determined RSSI); a valid data monitoring response event. The embodiment system performs a succession of changes and evaluation of the changes, for example with the last change being the reuse of a former antenna configuration when the monitored antenna performance degrades a certain amount.

The received signal of the beam forming device is below a predetermined signal to noise ratio (SNR); a valid data monitoring response event. The embodiment system performs a succession of changes and evaluation of the changes, for example with the last change being the reuse of a former antenna configuration when the monitored antenna performance degrades a certain amount.

The received signal of the beam forming device is below a predetermined valid data transfer rate (baud); a valid data monitoring response event. The embodiment system performs a succession of changes and evaluation of the changes, for example with the last change being the reuse of a former antenna configuration when the monitored antenna performance degrades a certain amount.

A user demands a change; a start event. The embodiment system reuses a former antenna configuration when the user demands a change.

When the change to a former antenna configuration does not produce the desired antenna performance in response to one of the above listed start events, further changes may be made in succession, with each being followed by an evaluation of performance. The successive changes may be, for example, change the transmit power, scanning, changing to an independent antenna or changing the channel. These changes may be tried in different orders as desired depending upon the importance of specific usage factors, such as efficiency of time, efficiency of effort, efficiency of power consumption, or the like.

When the change involves reconfiguration of the beam form of the smart antenna subsystem by scanning, the scanning parameters, such as the starting direction of rotating the smart antenna array may be chosen from a stored table, which chosen parameter is linked in the table to the best previous performance among the choices of parameters or the last antenna configuration. Thus the scanning starts from the best previous configuration rather than the current unsatisfactory configuration; this should save scan time needed to obtain a satisfactory performance; or just scan continuously as did in a conventional method.

When the change involves increasing the power, the power may be set to incremental increase until a certain threshold value or set to an increase that is chosen from a stored table, which chosen power is linked in the table to the best previous performance or to set to decrease to save power. Sometimes the request could be the reduction of the transmit power so as to save the power (or so as not to interfere with other devices). The upper threshold of maximum power can be limited by the radio regulatory, the wireless standards or the device. The transmit power describing here is the power from another terminal, i.e. the receiving terminal will request another terminal to change (boost) the power so as to achieve a better RSSI etc at the receiving terminals.

The receiving terminals could also change the transmit power in similar way, because another terminals could have the same problems: the reception is not good.

When the change involves changing to an independent antenna and there is more than one choice of new antenna, the new antenna is preferably chosen by using the available new antenna with the best previous performance as determined with reference to prior performance data in a stored table. The chosen antenna is thereby linked in the table to the best previous performance/s of that antenna among the choices of new antennas. The new antenna could have the better reception because of the antenna diversity (space or polarization diversity etc.), or the beam pattern.

When the change involves changing to a new available communication channel, a channel is chosen from a stored table, which chosen channel is linked in the table to the best previous performance. The new channel could be less crowded or less interferer compared to the last channel. The change involves changing the antenna and channel cannot necessarily be based on the previous data.

Thereby, according to the embodiment of the present invention, the change to affect performance, including configuration producing the beam form of the smart antenna, is event driven, occurs with respect to transmission of valid data, and is preferably based on a stored previous valid data transmission performance measurement.

Therefore, the present invention analysis of the prior art systems as to problems and their causes has lead to the need for and the solution of a more effective and efficient system for relatively fixed environments for a smart antenna.

Still other aspects, features, and advantages of the present invention are readily apparent from the following detailed description, simply by illustrating a number of particular embodiments and implementations, including the best mode contemplated by the inventor for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawing, in which like reference numerals refer to similar elements, and in which:

FIG. 1 discloses a simplified block diagram overview of a smart antenna wireless communication system according to an embodiment of the present invention, with a mechanical rotator for the array and an example table stored in the memory of the monitoring computer system;

FIG. 2 is a flowchart of the operation of the embodiment system of FIG. 1, which system includes an additional independent antenna, such as shown in FIGS. 8, 9 and 10.

FIG. 3 is a flowchart showing some of the operations of FIG. 2 in more detail and not showing other operations of FIG. 2 so as not to obscure the additional details.

FIG. 4 is a schematic of the receiver of the system of FIG. 7;

FIG. 5 is a schematic of the transmitter of the system of FIG. 7;

FIG. 6 shows the beam form and components of an exemplary adaptive array smart antenna subsystem of FIG. 1;

FIG. 7 is an overview of a wireless communication system of FIG. 1, using smart antennas according to the embodiment for both the terminals of the communication and showing the angles of departure and arrival with respect to scattered beams, wherein each terminal is a transmitter and/or a receiver;

FIG. 8 is an example of the embodiment system of FIG. 1, including an additional independent antenna that is an exemplary directional antenna;

FIG. 9 is an example of the embodiment system of FIG. 1, including an additional independent antenna that is an exemplary omni-directional antenna;

FIG. 10 is an example of the embodiment system of FIG. 1, including an additional independent antenna that is an exemplary adaptive smart antenna array subsystem;

FIG. 11 shows the beam form and components of a phase array smart antenna subsystem that may be the main or additional smart antenna subsystem of FIG. 10; and

FIG. 12 is a flowchart similar to FIG. 2, but showing a different order of performing the event driven changes.

### DETAILED DESCRIPTION

A smart antenna, for example an adaptive sectored antenna, is a well-know technology to obtain a narrow or shape the beam form for efficient wireless communication and therefore the details of the construction of a smart antenna subsystem will not be shown in detail to avoid obscuring the novel portions of the inventive combination. The smart antenna electronically and/or mechanically adapts to the environment.

The preferred embodiment satisfies the above-mentioned needs by solving the mentioned problems for a smart antenna, particularly used in a relatively fixed environment.

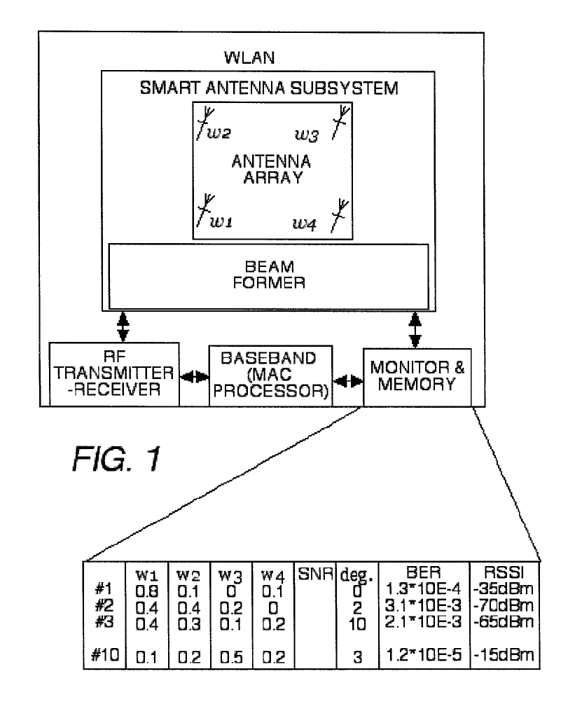

FIG. 1 shows an overview of the smart antenna wireless communication system, according to an embodiment of and best mode for practicing the present invention. FIG. 1 is particularly suited to a WLAN, by way of a specific example. As an example of means for scanning, a beam former changes the weighted power and/or phases to the individual antenna elements of the ANTENNA ARRAY to get the best available reception. Also, the beam former may be used in combination with a mechanical rotator to set the beam form more flexibly; as another example, a mechanical rotor may be used alone for digital TV. FIG. 1 also shows an example table stored in the memory of the monitoring computer system, MONITOR & MEMORY.

As is well known, a typical wireless communication system of this type also has: an RF (Radio Frequency), which is TRANSMITTER+RECEIVER having the function of frequency conversion and power boost; a BASE-BAND (BB) having the function of signal processing, for example modulation and coding; MAC (Medium Access Controller) having the function of transmission management (CSMA/CA, etc.); a PROCESSOR, which may perform the functions of the RF, BB and MAC; and a SMART ANTENNA SUBSYSTEM for beam forming.

The MONITOR is an antenna performance monitor according to the present invention that checks the communication performance as a function of the BER (Bit Error Rate), RSSI (Received Signal Strength Indication) and SNR (Signal-to-Noise-Ratio). RSSI is an indicator of the received signal and it may have units of voltage or the corresponding power (dBm or W). The MONITOR may be physically implemented with a general purpose computer that is programmed to be a special purpose computer as disclosed herein, particularly as described with respect to the flowcharts. At the present time, it appears that RSSI is the best parameter to use to judge the performance of the antenna configuration, and the others, such as SNR and BER may not in fact be used when RSSI is sufficient by itself as the parameter to be used to judge performance. The different parameters are important for different environments, for example, “Deg.” may be the parameter used in judging the performance of the antenna configuration for Digital TV.

The MONITOR is coupled in a well-understood manner to the BB, BEAM FORMER and MEMORY with appropriate interfaces. The MONITOR measures the power of the received signal, calculates the bit error rate (BER), communication baud and SNR (RSSI) of the received signal, and then stores the results and linking information in the MEMORY (for example, ROM or RAM). The signal processing unit of the MONITOR calculates the power weights w1, w2, etc. for the antenna elements used in scanning to obtain the optimum reception, based on the received valid data signal during wireless communication. The configuration parameters, such as w1, w2, w3, w4 and degrees of ANTENNA ARRAY rotation (deg.) are stored on the MEMORY in a linked relationship to the measured values of the performance parameters, such as baud, BER and RSSI. The recorded configuration parameters are preferably the ones optimized from monitoring the bit error rate (BER) and received signal strength indicator (RSSI) during a scan. This data is permanently stored for future use upon the occurrence of an event, as will be described hereafter.

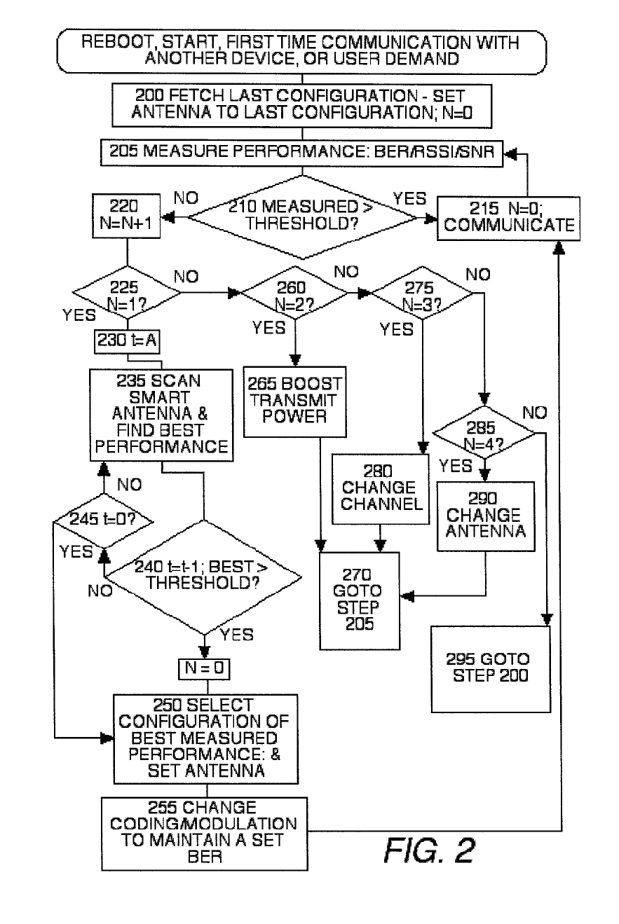

The MONITOR measures and calculates the BER, RSSI and SNR, which as an alternative could be done by the BASE-BAND. The MONITOR compares the measured data and predetermined data (thresholds or references) stored on the MEMORY continuously during transmission of valid data, and upon the occurrence of an event, the MONITOR commands the SMART ANTENNA SUBSYSTEM to change the configuration to get the best-performance. The MONITOR command could be to the BASE-BAND to scan the smart antenna, to change antennas, to change the transmission channel, to adjust the transmit power or to change the configuration to one of the previously stored configurations; this procedure will be described more particularly for the embodiment according to steps 200, 235, 290, 280 and 265 of FIG. 2, to find the best or a satisfactory configuration as determined by steps 240, and 210 of FIG. 2.

The MEMORY stores predetermined threshold or reference values for the performance parameters (for example: BER of 10 sup.-6) and measured data of previous scans that specify the SMART ANTENNA SUBSYSTEM configuration linked to measured SMART ANTENNA SUBSYSTEM performance obtained with the configurations, for example in the form of a table as shown in FIG. 1). Thus the MEMORY stores software, predetermined data of the thresholds for different usages, and a table that specifies past antenna configuration parameters, and the performances linked to such configurations, etc.

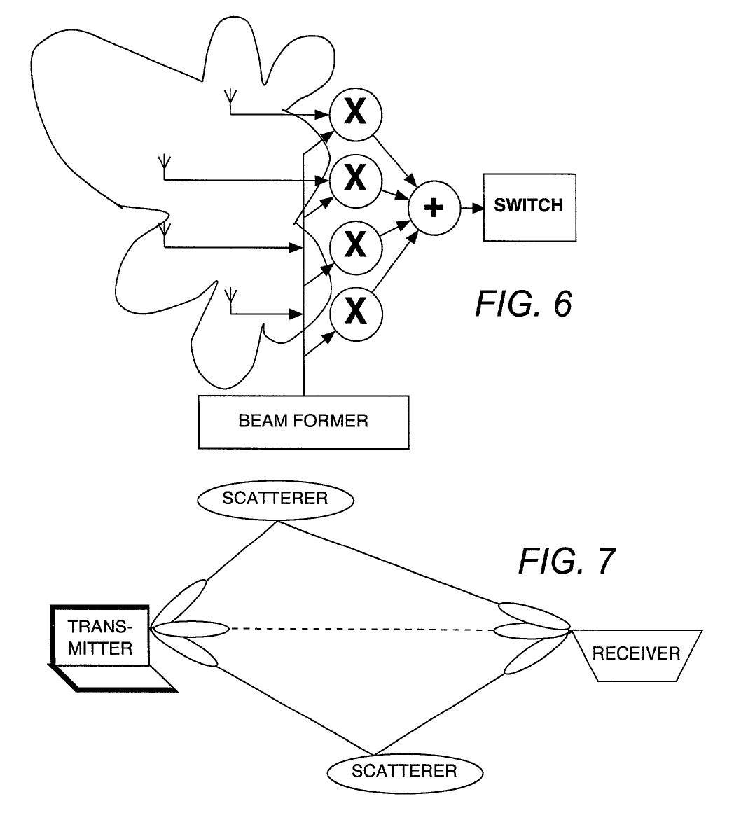

The SMART ANTENNA SUBSYSTEM has multiple directional antenna elements, four being shown as an example, in the ANTENNA ARRAY for receiving and transmitting data. An example beam steering system comprises the mentioned mechanical rotator, which operates by an order from the BASE-BAND or the performance MONITOR to rotate the ANTENNA ARRAY and assign the weighting of the signal power of the antenna elements, w1, w2, . . . wn. The ANTENNA ARRAY example contains n elements; n=4 in the example of FIG. 1. The n signals respectively from the n antennas are combined into one signal in a summing element, as shown in FIG. 6. The thus summed signal is the input to the rest of the receiver. The ANTENNA ARRAY will often have a relatively low number n of antenna elements in order to avoid unnecessarily high complexity in the signal processing.

An exemplary table in storage is shown in FIG. 1 with representative values. In the table, the degrees of rotation (deg.), mentioned above, which indicate the extent of rotation of the ANTENNA ARRAY are given for each configuration, which configurations are indexed as #1, #2, #3 . . . #10, for example. Also for each configuration, the table stores weighted values of power w1, w2, w3, w4 for each of the four antenna elements shown in the example for the ANTENNA ARRAY. The performance parameters measured during transmission, such as baud, BER, RSSI, SNR, etc. are stored in linked relationship to each of the configurations used during their measurement, respectively. Each configuration stored is a best-performance configuration obtained during a respective past performed scan. The table is updated or renewed for each scan to collect a plurality of past best configurations that are in permanent storage, that is the configurations in storage are held even when the transmission ceases or the system reboots, shuts down, etc.

The smart antenna, for example a sectored antenna, may have the antenna elements mounted in a triangle pattern or a back-to-back configuration or in-line configuration, but alternative arrangements are also possible and depend on factors such as the layout of an environment. The pattern of mounting the antenna elements and their specific antenna shape are not important to the present invention, so long as they can provide adequate antenna coverage. Antenna elements are often placed point symmetrically.

The RF components, TRANSMITTER and RECEIVER (a transceiver), function mainly to convert the frequency and boost the power of the wireless communication in a known manner. The RF transceiver receives from and transmits data to the antenna subsystem. The antenna performance parameters, such as baud, BER and the RSSI and SNR are generated from the received data by well-known methods. Further details of the transceiver will not be described to avoid obscuring the present invention.

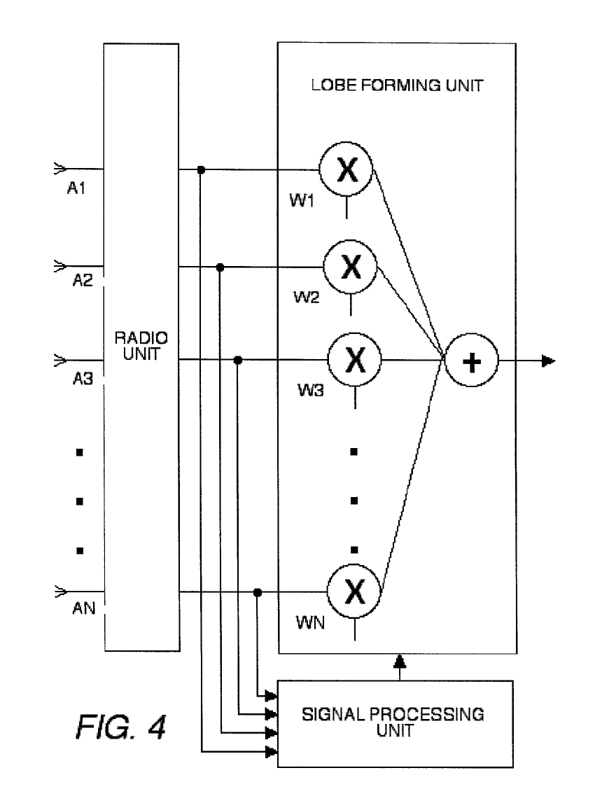

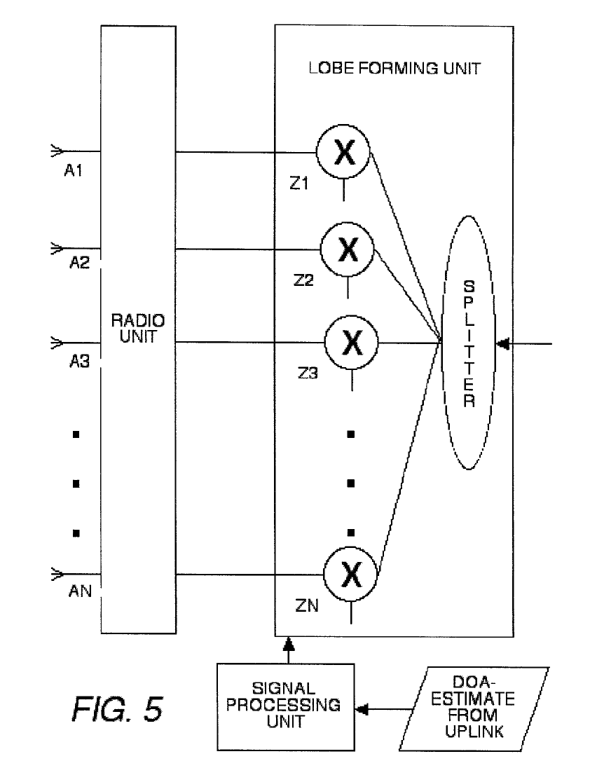

FIG. 4 is a schematic of the smart antenna subsystem as a receiver in the system of FIG. 7; and FIG. 5 is a schematic of the smart antenna subsystem as a transmitter in the system of FIG. 7. The components of FIGS. 4 and 5 are readily understood according to well-known conventions. The transmitter of the subsystem shown FIG. 5 is usually set with the power weightings (z1, z2, . . . zn) to form the beam (configure) for the optimum transmission. The receiver of the subsystem shown FIG. 4 is usually set with the power weightings (w1, w2, . . . wn) to form the beam (configure) for the optimum reception. The settings for transmission and reception may be the same or may be different when two ANTENNA ARRAYS are used respectively for reception and transmission, although one ANTENNA ARRAY could function for both reception and transmission., as optimum reception and transmission could happen through the same path. As mentioned the table in MEMORY of FIG. 1 holds these power weight settings for a plurality of past best configurations from a corresponding number of past scans

The beam steering (also commonly known in the art as null steering) in a state machine of the system includes a bit error rate (BER) compare unit that includes an input for receiving a bit error rate (BER) signal measured with respect to current communication of valid data and another input of a reference value, which could be a threshold, a percent degradation of a previous measured value or the like to determine if the performance has degraded a predetermined amount. Thus the BER compare unit compares the current BER signal with a predetermined performance reference, for example, a bit error rate threshold. The bit error rate is simply the ratio of the number of bits in error received and the number of correct bits received.

The beam steering state machine also includes a received signal strength indicator (RSSI) compare unit that includes an input for receiving an Received Signal Strength Indicator (RSSI) signal measured with respect to current communication of valid data and another input of a reference value, which could be a threshold, a percent degradation of a previous measured value or the like to determine if the performance has degraded a predetermined amount. The received signal strength indicator compare unit compares the received RSSI signal with the reference, for example, a predetermined RSSI threshold. RSSI represents the received signal power so the derivative communication performance could be estimated through the RSSI. By way of example, the predetermined RSSI threshold is set to −20 dBm (or it could be in the unit of voltage like 2.0V), above which tolerable system performance can be achieved. A RSSI threshold of less than the reference threshold yields unsatisfactory system results because the signal is weak enough not to support a certain system.

The RSSI compare unit and the BER compare unit may be a single compare unit having the two functions performed rapidly in succession. The outputs of the two functions (BER compare and RSSI compare) may be subject to a Boolean AND to generate a signal commanding a change, such as a new configuration of the ANTENNA ARRAY, a new channel, more power, a new antenna, a scan, etc.

The BASE-BAND, preferably employs medium access control (MAC) protocol, and has processor and digital circuits for digital signal processing, like coding, and modulation.

The embodiment sets forth events that determine the timing of when to change performance, for example when to scan or when to use a prior stored best-performance configuration, for a smart antenna in a fixed or almost fixed usage like a wireless local area network and a television system. Thereby the system maintains unchanged the parameters that determine the beam form of the smart antenna until the MONITOR recognizes one or a combination of more than one (for example a Boolean AND of a performance failure of both the BER and RSSI compare units) of the following conditions or event occurrences:

The device communicate with another device for the first time;

Reboot of the device or the device turns on (For example, turn on the host device (like a PC) with the system device, turn on the system device itself, and reboot the host device with the system device);

The received signal exceeds a predetermined bit error rate (BER);

The received signal strength indicator (RSSI) is less than a determined RSSI;

The received signal goes below a predetermined signal to noise ratio (SNR); and

User's demand.

The invention utilizes changing of the communication parameters, for example: the previous measured data to reduce the scan area and reduces the scan time (FIG. 6 shows an optimum beam form, which upon completion of the scanning is stored as one of the best-performance configurations in the table of FIG. 1); control of the transmission power of the communicating device to maintain performance or quality; channel selection to minimize collision in the transmission; switching to the another antenna (for example, space or polarization diversity); and change the modulation scheme or data rate (baud) to obtain the desired performance, for example to get the predetermined BER in the communication environment (Example: from changing from 64QAM to BPSK).

When compared to the prior art, the invention reduces the number of the smart antenna scans dramatically for a system that is almost fixed in terms of the device itself and also the radio conditions. Those options written above help to keep the communication quality and obtain the optimum scan.

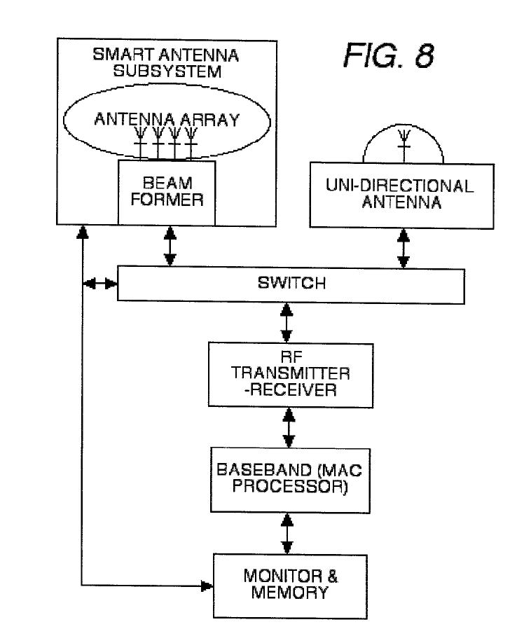

The principle of operation is shown with respect to the flowchart of FIG. 2, for the embodiment system, which system includes an additional independent antenna, such as shown in FIGS. 8, 9 and 10, for example. As to the flowcharts, each block within the flowcharts represents both a method step and an apparatus element for performing the method step. Depending upon the implementation, the corresponding apparatus element may be configured in hardware, software, firmware or combinations thereof.

FIG. 2, step 200: At some time previous to this step, the system was operational and the last used configuration (for example, #10 of FIG. 1) of the smart antenna system was stored in the MEMORY of FIG. 1, along with other previous best-performance configurations (for example #1 to #9 of FIG. 1). Upon the first communication between the wireless devices, or upon rebooting or turning on of the beam forming device, or other start function, the last configuration of the smart ANTENNA ARRAY of FIG. 1, for example the configuration #10 in the table, is fetched from the MEMORY, and the ANTENNA ARRAY is set to the fetched configuration, although few if any of its parameter settings may need changing since that was the last configuration used. A counter N, to control the orderly successive looping through procedures, is initialized, for example, N is set to equal 0; any other loop control or procedure order control could be used, for example those equivalent to IF, THEN statements.

FIG. 2, step 205: The MONITOR measures ANTENNA ARRAY performance and calculates to obtain the current values for baud, and/or BER, and/or RSSI and/or SNR, which values are temporarily stored as current performance values to be used for performance monitoring in step 210.

FIG. 2, step 210: The MONITOR compares the measured data from step 205 and predetermined performance reference data, for example, threshold data, which is stored on the MEMORY prior to step 200. This comparison is made for one or more of baud, BER, RSSI and SNR. When the comparisons show that the measured performance of Sep 205 meets the desired minimum performance requirements, processing proceeds to step 215, and otherwise proceeds to step 220. Failure to meet the performance standard may be selectively set to mean any one of or two of or more of baud, BER, RSSI and SNR. The standards and the number of standards are based on the required values to keep the communication useful for the particular application, and may be different for different usages. The embodiment threshold values are predetermined data of data rate, BER, RSSI and SNR; they are determined by or entered into the system MEMORY before step 205, and they are based on the required values to work the system effectively.

For example, a particular wireless data communication system could require a threshold BER of 10.sup-6, a wireless voice communication systems could require a threshold BER of 10.sup-3 etc. Another example of a threshold value is a data rate (baud) of 12 Mbps; and a higher data rate may be required for MPEG2, for example 20 Mbps.

If the operating IEEE802.11a wireless communication degrades a certain value or degrades below a certain value, that is the values of the performance references or predetermined data. Those values are dependent upon the performance required for a particular application of wireless communication. For example, a bit error rate of greater than the threshold yields unacceptable system performance because at such a BER the data is unreliable. The predetermined data (thresholds for baud, BER, etc.) as stored in the MEMORY, is based on parameters. The predetermined data may be user's requirements (for example, a moving picture with tiny screen requires a lower data rate).

The example threshold values are absolute values, but the performance reference values may also be relative value to the measured data, for example, 10% degradation from the previous measured data. The comparison equation, which compares the measured data and the predetermined data is for example: the predetermined BER is less than or equal to the measured BER, AND/OR the predetermined RSSI is more than or equal to the measured RSSI AND/OR the predetermined SNR is more than or equal to the measured SNR. As a specific example, if the detected BER and RSSI simultaneously meet the predetermined threshold values, a yes decision is rendered.

FIG. 2, step 215: Since the antenna performance is satisfactory, the configuration is not changed, which saves power and complexity, and the communication is continued. This step may also be reached from a loop to be described that successfully changed the antenna configuration, for example. Since in that case the change was successful, the counter N is initialized. Processing returns to step 205 to continue the monitoring of the antenna communication performance.

FIG. 2, step 220: This step is reached when step 210 has determined that the antenna performance is not up to the performance standard. The counter N is incremented to show that the next in a succession of changes is to be made in an effort to obtain a satisfactory performance.

FIG. 2, step 225: If the counter N equals 1, indicating the first change in the succession of changes is to be made, processing proceeds to step 230, otherwise processing proceeds to step 260 to try the second or a subsequent change. The order of the changes may be adjusted for different purposes; for example, if the initialization of the counter N is to the value 4 in steps 215 and 200, the counter could be decremented after each change to reverse the order of changes.

FIG. 2, step 230: A timer is initialized to a value selected to provide sufficient time to repeat scanning a desired number of times in trying to obtain a satisfactory or best-performance configuration. The value of A may be set to zero if only one scan is desired.

FIG. 2, step 235: The ANTENNA ARRAY is scanned, for example by rotating the ANTANNA ARRAY and measuring the degrees of rotation (deg. in the table of FIG. 1). Since scanning and determining the best-performance configuration is a well-known technology for smart antennas, it will not be set forth in detail here to avoid obscuring the novel components of the embodiment. The MEMORY stores the best-performance antenna configuration as a function of the measured performance, which storage is renewed for every scan, for example as shown in the memory table of FIG. 1. Best-performance refers to the smallest or minimum BER, the largest or maximum RSSI and the largest or maximum SNR and a data rate that is required by the usage. Since the best BER, RSSI and SNR may not occur at the same configuration, the relative importance of these parameters may be weighted as in fuzzy logic evaluation for an overall best-performance.

The scan process is preferably based on the previous performance table stored in the MEMORY, for example, to enable the scan periodically in space, relationships between beam form and weight w1, w1, . . . are stored in the MEMORY. That is, the scan may first successively try the stored best-performances from the table of the MEMORY, before performing a conventional scan of all possible configurations. By way of a further example, for totally different environments (ex. office and home etc) the scan may be periodic in space: 0 deg, 15 deg, 30 deg, 45 deg . . . 345 deg. In this case, the table can have some kinds of relationship between the angle of the main lobe and the power weight parameters beforehand. For the same environment but having a slight change (ex. additional partition between the communicating devices) the scan may be based on the previously stored best-performance configuration measurements 30 deg, 0 deg (best available), 270 deg, 0 deg (2^{nd} best). A scan procedure may be 28 deg, 32 deg, 40 deg, 270 deg etc., when 0 deg.

The communication is susceptible to external interference, which can stem from adjacent cells or from a source within the cell. The beam steering state machine, includes an interference reduction circuit to reduce such interferences, as is known in the prior art. The adaptive sectored antenna includes a movable sector of coverage or beam (i.e., it can be steered spatially), the interference reduction circuit is employed to steer the beam of the antenna to reduce the interference, in a known manner during the scan. Specifically, the beam steering state machine steers (i.e., to scan by selectively steering the antenna in a first spatial direction or a second spatial direction) the antenna to obtain the best BER and RSSI performance during transmission and/or reception of valid data. The interference reduction circuit selectively moves the sector of coverage or beam to alternative configurations to reduce the external interference based on interference indication signals, which is scanning and known so that further details of the scanning will not be set forth to avoid obscuring the novel portions of the present invention.

In an example of a person moving in front of the transmitter, signal degradation detected in step 210 that leads to step 235, the antenna can be steered (scanned) to receive a reflected signal that is of a higher quality than a direct signal that is being blocked by the object.

FIG. 2, step 240: The timer is decremented by setting t=t−1. Next the measured current performance is compared to the previous best performance of the same scan to obtain the best configuration performance of step 235 used to update the table, which comparison is similar to that with respect to step 210. The processing moves to step 245. Thereby within a limit of time or number of scans, the scanning continues until a best-performance is available, as measured by BER, RSSI and SNR. If the performance is satisfactory, the processing moves to step 250. If one of the antenna configurations of the scan of antenna parameters realizes a performance superior to the predetermined threshold value, then the MONITOR saves and/or renews the antenna parameters and those related data into the memory and processing proceeds to step 250, after first setting the counter to zero (N=0), and then processing moves to step 250.

FIG. 2, step 245: When the timer has not expired and the best-performance does not meet the performance reference that is preferably the same as that of step 210, steps 235 and 240 are repeated by step 240 generating a no result. When the timer has expired, processing passes to step 250.

FIG. 2, step 250: This step is reached when the best-performance configuration of the present scan meets the reference standard of performance in step 240, which may or may not be the last scan of step 235. The configuration that produced the satisfactory configuration is selected by being fetched from the MEMORY and then used as the current configuration of the ANTANNA ARRAY accordingly, that is the antenna is set. Step 250 is reached even though the scan cannot meet the predetermined reference performance, the system is stabilized using the best available performance of the scan under the conditions and to thereby communicate under the best available configuration.

FIG. 2, step 255: The coding rate and modulation are changed in view of the new configuration so as to maintain a set BER standard. The communication baud may also be changed in view of the new configuration. Next, the processing moves to step 205 to continue the communication and monitoring.

FIG. 2, step 260: When step 225 has determined that N does not equal 1 (it may equal 2, 3 or 4 in the embodiment) step 260 is reached. When the timer t has expired after unsuccessfully trying to meet the performance reference with the scanning of step 235, here threshold of step 240, and step 220 has incremented the counter N to 2, step 260 returns a YES and processing moves to step 265, otherwise step 275 is reached.

FIG. 2, step 265: The transmit power (the power from another terminal) to the antenna array is adjusted, as the next change to attempt to reach a satisfactory antenna or more broadly communication, performance. If the transmitting terminal, i.e. another terminal, boosts the transmit power, the receiving terminal can achieve a better RSSI, etc. the upper limit of the transmit power depends on the system (device) and the radio regulations (standards). Therefore the receiving terminal will request another terminal to change (boost) the power if there is an option to do so. Sometimes, the request could be for the reduction of the transmit power so as to save power or not to interfere with other devices. The receiving terminals could also change the transmit power, because another terminal could have the same problems, for example poor reception power.

FIG. 2, step 270: Step 270 returns the processing to step 205 to continue the communication and monitoring. The performance with the increased transmit power is measured in step 205 and checked in step 210; if satisfactory, the counter is initialized in step 215, but otherwise steps 220, 225 and 260 move the processing to step 275, because the counter is N=3. FIG. 2 is for a one-time increase in transmit power, but as an alternate performance, the power may be incrementally increased over a period of time with the addition of loop steps similar to steps 240 and 245 or increased a set number of increments (as determined by another counter) by looping through step 265 a set number of times and returning to step 210 without incrementing the counter N.

FIG. 2, step 275: When step 225 has determined that N does not equal 1 and step 260 has determined that N does not equal 2 (N may equal 3 or 4 in the embodiment) step 275 is reached. When N equals 3, processing moves to step 280, and otherwise processing moves to step 285.

FIG. 2, step 280: The MONITOR or Base-Band changes the communication channel as a change that may produce satisfactory performance. Another challenge of the home environment is that a communication channel is not static. In a home environment, the BER and the RSSI can degrade due to 1) an object moving in front of the transmitter or 2) misalignment of the antenna (e.g., physical displacement). A simple example is when a person stands in a direct path between a transmitter and a receiver, or another wireless device is using the same channels. If the new channel does not provide better performance than the previous channel, then the monitor returns to the previous channel. A new channel may provide better performance because of having less congestion than the previous channel. Thereafter, processing moves to step 270. Step 270 returns the processing to step 205 to continue the communication and performance monitoring. The performance with the new channel of communication is measured in step 205 and checked in step 210; if satisfactory, the counter is initialized in step 215, but otherwise steps 220, 225, 260 and 275 move the processing to step 285, because the counter is now N=4. A WLAN has many channels and therefore the channel used may be changed. But for digital TV, when you change the frequency channel, the program will change, for example from NBC to ABC, because the TV program channel and the transmission channel are the same frequency. Therefore, changing channels will not be an option in some environments.

FIG. 2 is for a one-time change in channel, but as an alternate performance when there are more than two channels available, the available channels may be successively selected with the addition of loop steps similar to steps 240 and 245, which looping is for a set number of times (as determined by another counter.

FIG. 2, step 285: When step 225 has determined that N does not equal 1, step 260 has determined that N does not equal 2 and step 275 has determined that N does not equal 3 (N may equal 4 in the embodiment) step 285 is reached. When N equals 4, processing moves to step 290, and otherwise processing moves to step 295.

FIG. 2, step 290: The MONITOR changes the communication antenna as a change that may produce satisfactory performance. If the new antenna does not provide better performance than the previous antenna, then the monitor returns to the previous antenna. Thereafter, processing moves to step 270. Step 270 returns the processing to step 205 to continue the monitoring. The performance with the new antenna for communication is measured in step 205 and checked in step 210; if satisfactory, the counter is initialized in step 215, but otherwise steps 220, 225, 260, 275 and 285 move the processing to step 295, because the counter is now N=5.

Step 290 may be modified to include a performance check with another antenna before the communication is changed to another antenna. Then the change to another antenna is only made if another antenna has a better performance than the threshold. As a further modification, even if the performance is not better than the threshold, the change to another antennae may be made if the performance is better than the currently used antenna configuration. Once the antenna change has been made, the procedure may move to step 230, as a further modification to scan the beam of the original antenna and switch back to the original antenna if the performance of the original antenna after scanning exceeds that of the another antenna; during the scan of the original antenna, communication is maintained with the another antenna.

FIG. 2 is for a one-time change of antenna, but as an alternate performance when there are more than two antennas available, the available antennas may be successively selected over a period of time with the addition of loop steps similar to steps 240 and 245 or looped a set number of times (as determined by another counter) by looping through step 280 and returning to step 210 without initializing the counter N. FIGS. 8, 9 and 10 disclose multiple antennas and the invention includes an implementation of three or more antennas in addition to the illustrated implementations of two antennas in these figures.

If you are moving continuously, the omni-antenna works well. In that situation, the system with only a smart antenna follows the positional relationship in each motion. In that case, let's say “wide reception mode”, the smart antenna is not functioning, so the system uses the omni-directional antenna.

FIG. 2, step 295: Processing moves to step 200, to revert to a previous configuration, as a start event even though communication may continue. FIG. 2 is for a one-time reversion to a previous configuration (the last best-performance configuration, for example configuration #1 of FIG. 1) that is stored in MEMORY, but the embodiment has more best-performance configurations stored in the MEMORY (configurations #1 to #9, of the example table shown in FIG. 1), the available stored previous configurations may be successively selected over a period of time with the addition of loop steps similar to steps 240 and 245 or looped a set number of times (as determined by another counter) by looping through step 295 and 200 and returning to step 210 without initializing the counter N; the counter could be incremented to a value greater than 4 and process 295 would still be reached.

The system performance data measured in step 205 is a function of coding rate/modulation/data rate, and therefore it is contemplated to change coding rate/modulation/data rate based on the available performance. For example, to get a BER=10 sup-6, 13.5 dB of SNR is required for QPSK modulation. If the best available data is 20 dB, then change the modulation method to QPSK so as to keep a certain BER (predetermined BER). Thus, such a change is reached with a new testing step, for example, between steps 285 and 295 to see if N−5 and if it does to go to such a change step of changing one or more of coding rate, modulation and data rate, and if N does not equal 5 then to move to step 295.

The beam form employed for wireless communication is changed upon the occurrence of one or more of the following events. The previous antenna configuration is loaded upon wireless communicating with another device for the first time, FIG. 2, START and step 200; a start event. The received signal of the beam forming device is above a predetermined bit error rate (BER), FIG. 2, steps 205 and 210; a performance monitoring event. The embodiment system reuses a former antenna configuration when the monitored antenna performance degrades a certain amount, FIG. 2, steps 295 and 200; a combination start event and performance monitor event. The received signal strength indicator (RSSI) of the beam forming device is less than a determined RSSI, FIG. 2, step 205 and 210; a performance monitoring event. The received signal of the beam forming device is below a predetermined signal to noise ratio (SNR), FIG. 2, step 205 and 210; a performance monitoring event. The previous antenna configuration is loaded upon a user's demand for a change, FIG. 2, START and step 200; a start event.

With reference to FIG. 2, the changes (using a previous stored best-performance configuration according to step 200, scanning according to step 235, boosting power according to step 265, selecting another available channel according to step 280, selecting another available antenna according to step 290, changing coding according to step 255, changing modulation according to step 255, changing baud, etc.) configure the antenna to get the satisfactory or best-performance as determined by steps 205, 210, 235 and 240. The antenna configuration would be fixed until the MONITOR notices the degradation at a certain value, step 210. The threshold used in steps 210 and 240 as the predetermined data, could vary (for example be one of a succession of decreasing standards to be used successively when a previous standard cannot be met, with resetting to the highest standard after an elapsed time or upon an event), and could be specified selectively by the user or automatically by a sensed usage to depend on a standard (WLAN/WPAN/TV), an application(voice or data), modulation scheme(BPSK/64QAM)and a required data rate(6 Mbps/54 Mbps), for example.

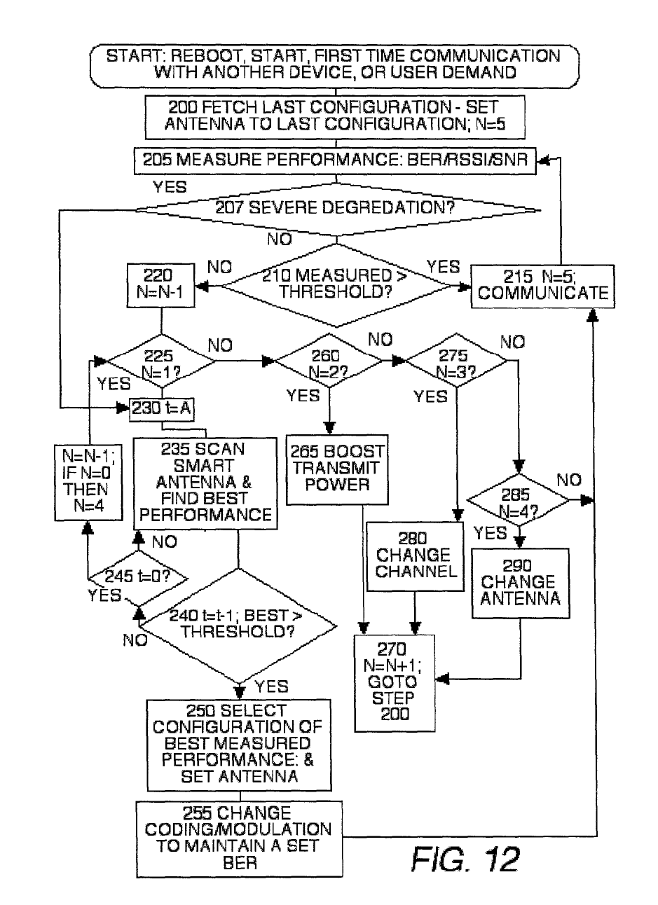

The process of FIG. 12 is the same as the process of FIG. 2, except that Step 207 has been added and the order of performing steps 235, 265, 280 and 290 has been changed, as another example of step order. The process of FIG. 12 may be useful when the wireless system has a battery or otherwise limited power supply and therefore power hungry steps such as steps 265 and 235 are placed near the end of the order of performance. Step 207 makes a determination if the degradation of the performance is severe, for example 10% degradation of the last measured BER or the threshold value. When the degradation is severe, the system again would start scanning the beam form and renewing the table until the system got the predetermined performance (or the best available value). The time of the beam scan can be reduced by referring to the table, which has previous measured best-performance data, for example to find a most likely starting scan direction or an entire starting configuration.

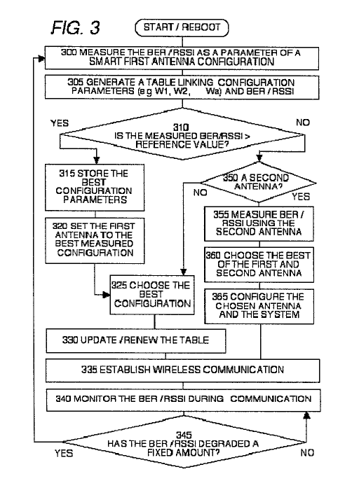

FIG. 3 is a flowchart showing some of the operations of FIG. 2 in more detail, and is a flowchart not showing other operations of FIG. 2, so as not to obscure the additional details. FIG. 3 obtains better performance by switching the smart antenna to another available antenna that has another directivity response pattern. The switching could gain the better performance as the antenna that has a beneficial spatial diversity and directivity diversity. Steps 350, 355, 360 and 365 alternatively are details of step 290 of FIG. 2. Steps 300 and 305 are also details of steps inserted before step 200 of FIG. 2. Steps 315, 320, 325 and 330 are also details of procedures performed as a part of step 215 of FIG. 2.

Another way of looking at FIG. 3 is that it shows an operation that is limited to less than all of the changes specifically set forth in FIG. 2, namely FIG. 3 being limited to changing antennas, applicable to the physical implementations of FIGS. 8, 9 and 10.

Therefore, within the scope of the invention, is a combination of all of the features of FIGS. 2 and 3, which may be modified: as exemplified by FIG. 12, to change the order of the steps to any of the possible orders of the changes that affect performance; or as exemplified by FIG. 3, to simplify by deleting one or more of the steps.

The protocol of FIGS. 2, 3 and 12 may be implemented in software implemented in machine-readable code on the media of the MEMORY and executed on a personal computer or, the software can be implemented in a gate array or a programmable logic circuit. A computer system in which the control of the smart antenna, for example a sectored antenna of the present invention, can be implemented to include a radio subsystem with antenna for receiving and transmitting radio signals, a serial interface coupled to the radio subsystem with antennae for interfacing data received from the radio subsystem into a serial format, and a desktop personal computer having a serial interface.

FIG. 6 shows the beam form and components of an adaptive array SMART ANTENNA SUBSYSTEM of FIG. 1, with other details. The beam form is determined. with the embodiment antenna elements, by the weights w1, w2 etc. assigned to proportion the total transmit power among the antenna elements and the weights z1, z2 etc. assigned to proportion the total receive power among the antenna elements, and the degree (deg. of FIG. 1) of rotation of the ANTENNA ARRAY. The scanning of step 235, FIG. 2 scans through different combinations and values for the weights w1, w2 etc., the weights z1, z2 etc., and the degrees (deg.). The direction of the main lobe of the beam form is correlated to the weighted power of each antenna (w1, w2, z1, z2, etc.) and the position information (deg.).

FIG. 8 is an example of the embodiment system wherein the additional independent antenna, of step 290 in the process of FIG. 2 and of step 350 in the process of FIG. 3, is a directional antenna.

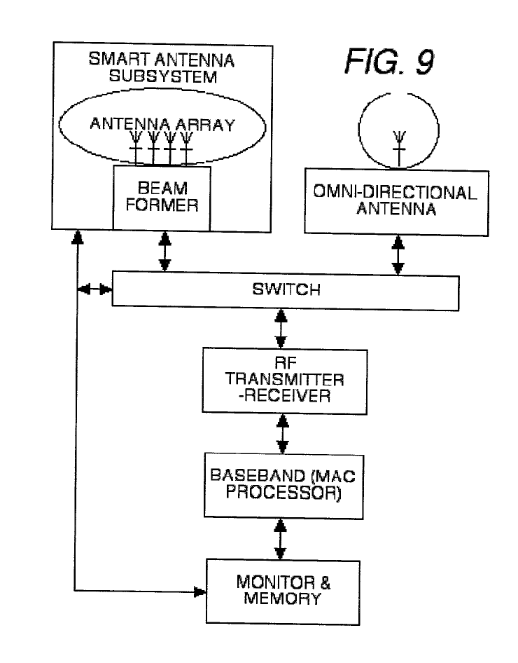

FIG. 9 is an example of the embodiment system wherein the additional independent antenna, of step 290 in the process of FIG. 2 and of step 350 in the process of FIG. 3, is an omni-directional antenna;

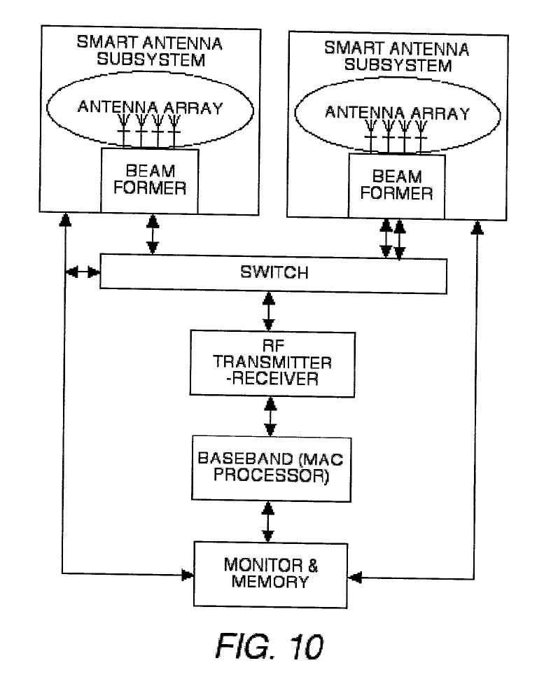

FIG. 10 is an example of the embodiment system wherein the additional independent antenna, of step 290 in the process of FIG. 2 and of step 350 in the process of FIG. 3, is an adaptive smart antenna array subsystem.

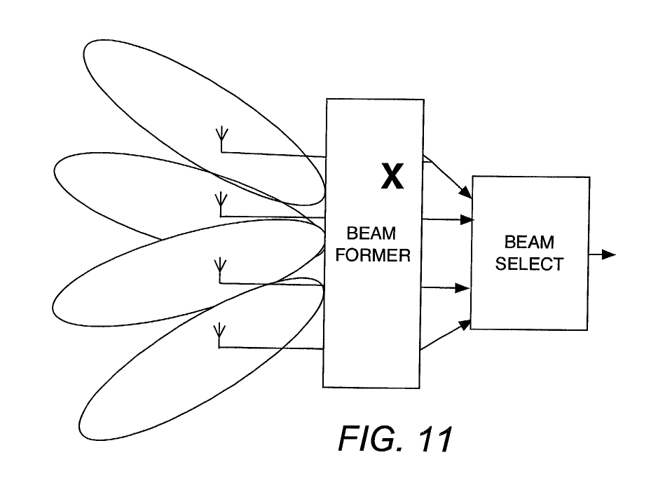

FIG. 11 shows the beam form and components of a phase array smart antenna subsystem that may be the independent next used antenna of step 290 in the process of FIG. 2 and step 350 in the process of FIG. 3, or which may be used as the main smart antenna subsystem of FIG. 1.

Experimental results show that with a stationary terminal, like a wireless local area network system or a wireless television system, their spatial signature will remain virtually constant over long periods of time. What constitutes a long period of time is relative to the computational speed of the monitoring system and applicable computers are faster each year. Thus, a long period of time when the invention would be usefully employed would involve the period of time that a conventional continuously scanning system would accomplish many scans while the system of the present invention would not have a performance that would show a degradation sufficient to find an unsatisfactory performance result of NO for step 210 of FIG. 2. Thus the present system would not change the parameters of the configuration, etc. according to steps 235, 265, 280 and 290 during such a long period of time. Therefore, the present invention reduces computational overhead on the network and reduces power overhead by not continuously scanning etc. to find the best, although unnecessary, configuration at small intervals of time.

The user of the antenna system can set information specifying the mode of the antenna system in the memory of the antenna system. The modes are:

(a) The antenna system will read an antenna set up information that was used in the past communication and the system set up by using the antenna set up information. The set up is executed at the system start.

(b) The antenna system executes the set up procedure (a). After that, when the quality of the communication becomes low, the system changes the value for set up of the antenna.

Also, the mode may be specified automatically based on the performance parameters, for example those mentioned herein, or power consumption parameters of the equipment.

Whether user set or automatically set, these modes are useful for the equipment that has a possibility to be used under both fix and mobile conditions.

The present invention demonstrates the feasibility of utilizing beam-forming techniques in a relatively fixed environment.

Beam steering according to the present invention need not happen every transmission or reception as is done in a cellular phone system and other prior art systems.

The present invention maintains good wireless communication performance with less scanning effort, power, expense and computational overhead than the prior art.

The main application of this invention is to provide optimum smart antenna configuration for fixed wireless communication systems like wireless networks (WLANs, Wireless Local Area Network and WPANs, Wireless Personal Area Network, for example IEEE802.11b, IEEE802.11a, Bluetooth, HomeRF) and digital television systems employing a smart antenna.

The invention applies smart antenna technology to fixed wireless networks. The invention is also applicable to smart antennas that will operate in mobile systems, where the speed of processing is sufficiently fast to permit the mobile system to be controlled as a substantially fixed location system. For example a laptop is seldom moved while in operation although it is considered as a mobile computing system with wireless communication. A wireless communication with a hand held cell phone may be controlled with the present invention when the processing speed is such that scanning does not need to be continuous even when the user is moving slowly or when the user has long periods of being stationary. A wireless communication with a vehicle may be controlled with the present invention when the processing speed is such that scanning does not need to be continuous even when the vehicle is moving or the present invention is used when the vehicle has long periods of being stationary of in dense slow moving traffic. Therefore, this invention allows smart antennas to operate in both fixed and mobile wireless networks and allows smart antennas to work in any topology by monitoring the effects of beam scatters and other factors affecting performance.

The existing solutions to wireless communication use dumb omni-directional antennas. The invention details how smart antenna scanning can be applied in a practical way, particularly to relatively fixed wireless LANs.

Use of this invention will reduce power consumption and reduce component cost.

While the present invention has been described in connection with a number of embodiments and implementations, the present invention is not so limited but covers various obvious modifications and equivalent arrangements, which fall within the purview of the appended claims.

What is claimed is:

1. A smart antenna system for wireless communication between devices, comprising:
a smart antenna subsystem adapted to be spatially steered and including an antenna array of a plurality of directional antenna elements, and further including a beam former;
a wireless communicator;
a baseband unit;
a performance monitor;
a memory;
a signal processing unit to scan configurations of and form a beam of the antenna subsystem;
said performance monitor measuring a bit error rate (BER) and/or received signal strength indicator (RSSI) and/or SNR; and
said memory having a machine readable media with a machine readable code representative of the measured BER and/or RSSI and/or SNR linked to different past configurations of the smart antenna subsystem.

2. A smart antenna system for wireless communication between devices, comprising:
a smart antenna subsystem unit adapted to be spatially steered and including an antenna array of a plurality of directional antenna elements, and a beam former;
a wireless communicator unit;
a performance monitor;
a memory;
a signal processing unit to scan configurations of and form a beam of the antenna subsystem;
said performance monitor measuring a bit error rate (BER) and/or received signal strength indicator (RSSI) and/or Signal to Noise Ratio (SNR) during normal valid data wireless communication with said smart antenna subsystem;
said memory having a machine readable media with a machine readable code representative of performance reference values for BER and/or RSSI and/or SNR;
said performance monitor comparing the measured BER and/or RSSI and/or SNR with the performance reference values for BER and/or RSSI and/or SNR, respectively, on a substantially continuous basis during communication of valid data and producing a signal when the comparing indicates a predetermined degradation of performance; and
said performance monitor, coupled to at least one of said units, and being responsive to the signal to generate a command to said at least one of said units to change the beam form of said smart antenna subsystem.

3. The smart antenna system of claim 2, wherein:
said wireless communicator unit has a plurality of channels for communication with said smart antenna subsystem, and said change control unit changes operative channels in response to the command.

4. The smart antenna system of claim 2, further including:
another antenna;
an antenna switch selectively coupling one of said smart antenna subsystem and said another antenna to said wireless communicator, and
said antenna switch being responsive to said command to change the antenna to said another antenna to obtain a best-performance making use of spatial diversity and/or polarization diversity.

5. The smart antenna system of claim 2, wherein:
said monitor adjusts transmit power in response to the command to obtain a best-performance.

6. An antenna system for wireless communication between relatively fixed locations, comprising:
a smart antenna subsystem adapted to be spatially steered, including an array of antenna elements and a beam former to scan and shape the beam of the array;
a performance monitor coupled to said signal processor to measure wireless communication performance;
a memory storing a plurality of past configurations of said smart antenna subsystem; and
said monitor commanding said smart antenna subsystem to change to one of said past configurations upon the occurrence of a predetermined event.

7. The system of claim 6, wherein:
the event is a machine originating start event.

8. The system of claim 6, wherein:
said monitor generates the event when communication performance degrades a predetermined amount.

9. A wireless data communication system for a relatively fixed environment, comprising:
a smart antenna subsystem adapted to be spatially steered;
a monitor couple to continuously receive valid data during communication and continuously generate updated performance data; and
said monitor having a comparator generating a beam form change command in response to a comparison of the updated performance data with a predetermined performance reference indicating a predetermined degradation of performance.

10. The system of claim 9, wherein:
said smart antenna subsystem has a plurality of channels for communication and said monitor changes operative channels in response to the command.

11. The system of claim 9, further including:
another antenna;
an antenna switch selectively coupling one of said smart antenna subsystem and said another for system communication; and
said antenna switch being responsive to said command to change the antenna to said another antenna.

12. The system of claim 11, further including:
a scan unit responsive to said command for scanning and optimizing the beam form to get better performance: and
said antenna switch being responsive to the occurrence of both said command and a predetermined amount of the scan to change the antenna to said another antenna to obtain a best-performance making use of spatial diversity and/or polarization diversity.

13. The system of claim 9, further including
a scan unit responsive to said command for scanning and optimizing the beam form to get better performance.

14. The system of claim 9, wherein:
said monitor adjusts power of said smart antenna subsystem in response to the command.

15. A method performed by a machine for wireless communication with a smart antenna system in a relatively fixed environment, comprising the steps of:
performing a start operation for the system; and
in response to said start operation, configuring the smart antenna to a configuration stored into a memory prior to said start operation.

16. The method of claim 15, wherein:
said start operation is a first time wireless communication with a device using another antenna.

17. The method of claim 15, wherein:
said start operation is one of a system boot and reboot.

18. The method of claim 15, further comprising:
scanning the smart antenna; and
wherein said start operation is the start of said step of scanning.

19. The method of claim 18, further comprising:
said scanning successively configuring the smart antenna to each configuration selected from among a plurality of best-performance configurations achieved from prior scans and stored into a memory prior to said step of scanning; and
configuring the smart antenna to the best-performance configuration of said scanning.

20. The method of claim 15, wherein:
said start operation is in response to a human originating user demand event.

21. The method of claim 15, wherein:
said start operation is in response to a machine originating event.

22. A method performed by a machine for wireless communication with a smart antenna system in a relatively fixed environment, comprising the steps of:
wireless communicating valid data with a fixed smart antenna configuration having a beam shape;
monitoring said wireless communicating for a predetermined degradation of performance; and
in response to the predetermined degradation, changing the beam shape of the smart antenna.

23. The method of claim 22, further comprising:
maintaining in storage a plurality of best-performance configurations from past scans of the smart antenna; and
wherein said changing includes configuring the smart antenna according to a selected one of the stored plurality of best-performance configurations.

24. The method of claim 22, wherein:
said changing includes scanning the smart antenna until achieving one configuration of a best performance and a performance not having the predetermined degradation.

25. The method of claim 22, further comprising:
said scanning successively configuring the smart antenna to each configuration selected from among a plurality of best-performance configurations achieved from prior scans and stored into a memory prior to said step of scanning; and
configuring the smart antenna to the best-performance configuration of said scanning.

26. The method of claim, 25 further comprising:
after said step of scanning, configuring the antenna to the best performance configuration of said step of scanning and returning to said step of monitoring, without interrupting said communicating.

27. The method of claim, 26 further comprising:
after said step of scanning, changing the coding of said step of wireless communicating to maintain a set bit error rate (BER).

28. The method of claim 22, wherein
said step of monitoring includes measuring the bit error rate (BER) and a signal to noise ratio (SNR), and comparing the BER and SNR to respective predetermined data for determining the predetermined degradation.

29. The method of claim 22, wherein:
said changing includes switching said wireless communicating step to another antenna.

30. The method of claim 22, wherein:
said changing includes switching the channel of said wireless communicating step.

31. The method of claim 22, wherein:
said changing includes adjusting power of said wireless communicating step.

32. The method of claim 22, wherein:
said changing includes configuring the smart antenna to a configuration stored into a memory prior to said step of changing.

33. The method of claim 22, wherein:
said changing includes configuring the smart antenna to a configuration selected from among a plurality of best-performance configurations achieved from prior scans and stored into a memory prior to said step of changing.
